(19) United States
(12) Patent Application Publication
(10) Pub. No.: US 2026/0120444 A1
(43) Pub. Date: Apr. 30, 2026

(54) SYSTEMS AND METHODS FOR FEATURE ALIGNMENT WITH UNCERTAINTY-GUIDED REGIONAL ATTENTION FOR MULTIMODAL FUSION IN AN AUTONOMOUS VEHICLE

(71) Applicant: Torc Robotics, Inc., Blacksburg, VA (US)

(72) Inventor: Bin Jia, Columbia, MD (US)

(21) Appl. No.: 18/927,484

(22) Filed: Oct. 25, 2024

(51) Int. Cl. G06V 10/80; G06T 7/50; G06V 10/77; G06V 10/82; G06V 20/56

(52) U.S. Cl. CPC G06V 10/806; G06T 7/50; G06V 10/7715; G06V 20/56; G06T 2207/20076; G06T 2207/20084; G06T 2207/30252; G06V 10/82

(57) ABSTRACT

An autonomy computing system of an autonomous vehicle for feature alignment in multimodal fusion is provided. The processor of the autonomy computing system is programmed to receive a first feature map of an environment and a second feature map of the environment. The autonomous vehicle is operating in the environment. The processor is further programmed to fuse the first feature map and the second feature map into a fused feature map by associating first cells in the first feature map with second cells in the second feature map based on at least one of uncertainty in the first feature map or uncertainty in the second feature map and determining the fused feature map based on attention between the first feature map and the second feature map among associated cells. The processor is also programmed to control operation of the autonomous vehicle based on the fused feature map.

### TECHNICAL FIELD

The field of the disclosure relates generally to autonomous vehicles and, more specifically, to feature alignment for multimodal fusion in an autonomous vehicle.

### BACKGROUND OF THE INVENTION

An autonomous vehicle relies on multi-modal perception systems to detect objects and features in the environment, in which the autonomous vehicle is operating or traveling. Features detected by different modalities are fused into a fused feature map for the control of the autonomous vehicle. Attention has been applied in multimodal fusion to increase the accuracy in fusion. In at least some known methods, global attention is applied, where attention between a cell in one modality and all cells in another modality is computed, placing a heavy demand for computation power and memory. In at least other known methods, local attention is applied, where attention between a cell in one modality and cells in a fixed window in another modality is computed, potentially excluding information from cells outside the fixed window and wasting computer resources on unnecessary cells inside the fixed window. As a result, the reduction in demand for computer resources in typical local attention comes with the price of reduced accuracy in fusion. Accordingly, it is desirable to provide systems and methods for improved feature alignment using attention for multimodal fusion.

This section is intended to introduce the reader to various aspects of art that may be related to various aspects of the present disclosure described or claimed below. This description is believed to be helpful in providing the reader with background information to facilitate a better understanding of the various aspects of the present disclosure. Accordingly, it should be understood that these statements are to be read in this light and not as admissions of prior art.

### SUMMARY OF THE INVENTION

In one aspect, an autonomy computing system of an autonomous vehicle for feature alignment in multimodal fusion is provided. The autonomy computing system includes at least one processor in communication with at least one memory device. The at least one processor is programmed to receive a first feature map extracted from first sensor data of an environment and a second feature map extracted from second sensor data of the environment. The autonomous vehicle is operating in the environment. The first sensor data are from one or more sensors of a first modality, and the second sensor data are from one or more sensors of a second modality. The one or more sensors of the first modality and the one or more sensors of the second modality are installed on the autonomous vehicle. The at least one processor is further programmed to fuse the first feature map and the second feature map into a fused feature map by associating first cells in the first feature map with second cells in the second feature map based on at least one of uncertainty in the first feature map or uncertainty in the second feature map and determining the fused feature map based on attention between the first feature map and the second feature map among associated cells. The at least one processor is also programmed to control operation of the autonomous vehicle based on the fused feature map.

In another aspect, a method for feature alignment in multimodal fusion of features in an environment of an autonomous vehicle is provided. The method includes receiving a first feature map extracted from first sensor data of the environment and a second feature map extracted from second sensor data of the environment. The autonomous vehicle is operating in the environment. The first sensor data are from one or more sensors of a first modality, and the second sensor data are from one or more sensors of a second modality. The one or more sensors of the first modality and the one or more sensors of the second modality are installed on the autonomous vehicle. The method also includes fusing the first feature map and the second feature map into a fused feature map by associating first cells in the first feature map with second cells in the second feature map based on at least one of uncertainty in the first feature map or uncertainty in the second feature map and determining the fused feature map based on attention between the first feature map and the second feature map among associated cells. In addition, the method includes controlling operation of the autonomous vehicle based on the fused feature map.

Various refinements exist of the features noted in relation to the above-mentioned aspects. Further features may also be incorporated in the above-mentioned aspects as well. These refinements and additional features may exist individually or in any combination. For instance, various features discussed below in relation to any of the illustrated examples may be incorporated into any of the above-described aspects, alone or in any combination.

### BRIEF DESCRIPTION OF DRAWINGS

The following drawings form part of the present specification and are included to further demonstrate certain aspects of the present disclosure. The disclosure may be better understood by reference to one or more of these drawings in combination with the detailed description of specific embodiments presented herein.

FIG. 1 is a schematic diagram of an autonomous vehicle.

FIG. 2 is a block diagram of an autonomous vehicle.

FIG. 3 is a schematic diagram showing architecture of an example neural network model for multimodal fusion.

FIG. 4A is a schematic diagram showing an example process of associating cells in a feature map of a first modality with cells in a feature map of a second modality for computing attention between the two modalities.

FIG. 4B is a schematic diagram showing another example process of associating cells in a feature map of a first modality with cells in a feature map of a second modality for computing attention between the two modalities.

FIG. 5 is a flow chart of an example method for feature alignment.

FIG. 6A is a schematic diagram of a neural network model.

FIG. 6B is a schematic diagram of a neuron in the neural network model shown in FIG. 6A.

FIG. 7 is a block diagram of an example computing device.

Corresponding reference characters indicate corresponding parts throughout the several views of the drawings. Although specific features of various examples may be shown in some drawings and not in others, this is for convenience only. Any feature of any drawing may be referenced or claimed in combination with any feature of any other drawing. The drawings are not to scale unless otherwise noted.

### DETAILED DESCRIPTION

The following detailed description and examples set forth preferred materials, components, and procedures used in accordance with the present disclosure. This description and these examples, however, are provided by way of illustration only, and nothing therein shall be deemed to be a limitation upon the overall scope of the present disclosure.

The disclosed systems and methods are described, for clarity, using certain terminology when referring to and describing relevant components within the disclosure. Where possible, common industry terminology is employed in a manner consistent with its accepted meaning. Unless otherwise stated, such terminology should be given a broad interpretation consistent with the context of the present application and the scope of the appended claims.

Systems and methods for feature alignment in multimodal fusion by an autonomy computing system of an autonomous vehicle using uncertainty-guided regional attention is provided. As used herein, uncertainty-guided regional attention refers to a mechanism of computing attention, where attention is computed between a cell in a feature map from a first modality and cells in a region in a feature map from a second modality, where the region is adjusted based on uncertainty of features in the feature maps. Uncertainty refers to the lack of confidence for the estimation or prediction by a machine learning model. Modalities, such as a camera modality and light detection and ranging (LiDAR), are described as examples for illustration purposes only. The systems and methods described herein may be applied in multimodal fusion with attention between any two modalities. For example, the systems and methods may be applied for computing attention between features from radio detection and ranging (radar) and features from a camera modality, or between features from one camera modality, such as stereo cameras, and features from another camera modality, such as one or more gated cameras.

In at least some known methods, attention is performed as global attention, where attention between all feature points of one modality and all feature points of another modality is determined. Global attention is computation heavy and place a heavy demand on memory, resulting in a relatively low efficiency. Global attention may be a cause of reduction in the speed of computation and, due to the limited computer resources onboard an autonomous vehicle, potentially compromise operation of the autonomous vehicle. In at least some other known methods, local attention is applied, where attention between feature points of one modality in a fixed window and features points of another modality in a fixed window is determined. The size of the fixed window is empirically determined. Although the computation and memory demand are reduced, local attention focuses on regions in feature maps equally, potentially losing relevant information from features points outside the fixed window or wasting computer resources on unnecessary features points inside the fixed window. Besides having relatively low efficiency in determining attention like global attention, local attention suffers from reduced accuracy.

In contrast, the systems and methods described herein apply flexible regions adjusted based on uncertainty. When uncertainty for a feature point is relatively small, where the confidence in the feature point is relatively high, the region or regions associated during attention computation is relatively small, thereby increasing the computation speed and memory demand by excluding unnecessary feature points. When uncertainty for a feature point is relatively large, where the confidence in the feature point is relatively low, the region or regions associated during attention computation is relatively large to increase the number of potentially salient feature points for computing attention. As a result, the computation and memory demand is reduced without excluding potentially salient feature points, thereby increasing computation speed and reducing complexity of the system while increasing accuracy in fusion. Unlike global attention in at least some known methods, the size of the machine learning model in the systems and methods described herein is reduced, thereby reducing deployment difficulty, such as training data size and computation resource consumption, further increasing the efficiency of the system.

Uncertainty determined based on depth uncertainty is described herein for illustration purposes only. Uncertainty in any features in any combination may be used to enable the systems and methods to function as described herein. For example, uncertainty may be due to causes such as sensor failure, sensor extrinsic changes from vibrations, weather, and/or any other causes.

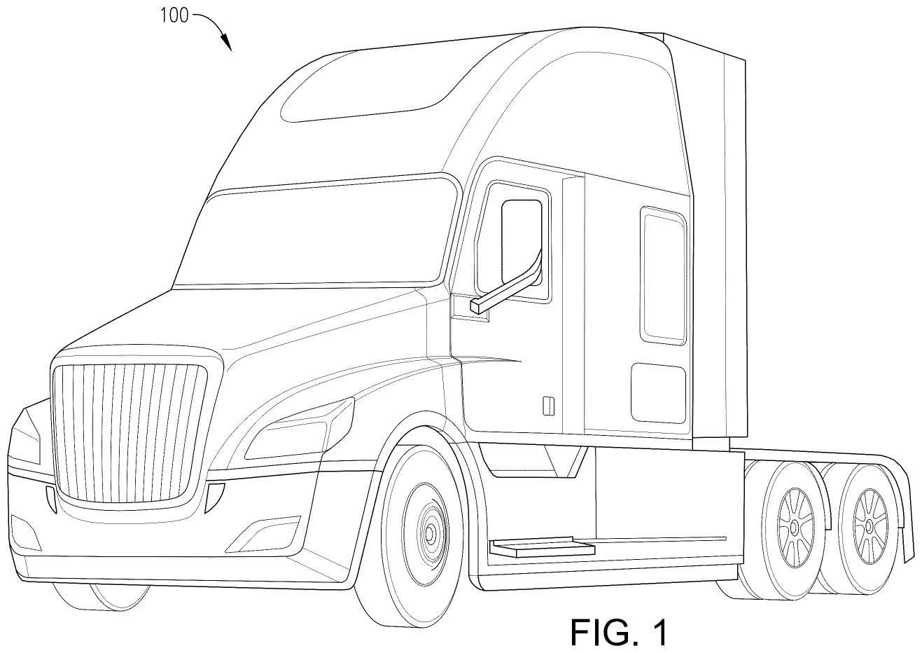

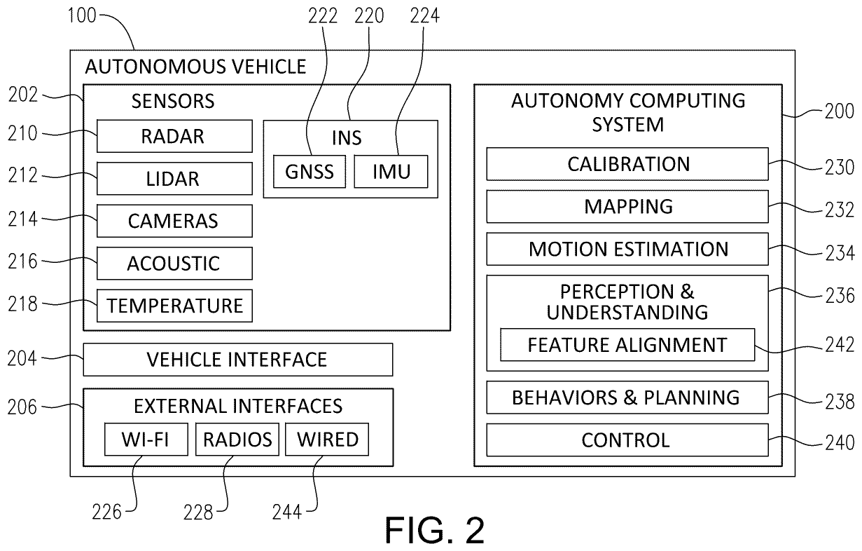

FIG. 1 is a schematic diagram of an autonomous vehicle 100. FIG. 2 is a block diagram of autonomous vehicle 100 shown in FIG. 1. In the example embodiment, autonomous vehicle 100 includes autonomy computing system 200, sensors 202, a vehicle interface 204, and external interfaces 206.

In the example embodiment, sensors 202 may include various sensors such as, for example, radio detection and ranging (radar) sensors 210, light detection and ranging (LiDAR) sensors 212, cameras 214, acoustic sensors 216, temperature sensors 218, or inertial navigation system (INS) 220, which may include one or more global navigation satellite system (GNSS) receivers 222 and one or more inertial measurement units (IMU) 224. Other sensors 202 not shown in FIG. 2 may include, for example, acoustic (e.g., ultrasound), internal vehicle sensors, meteorological sensors, or other types of sensors. Sensors 202 generate respective output signals based on detected physical conditions of autonomous vehicle 100 and its proximity. As described in further detail below, these signals may be used by autonomy computing system 200 to determine how to control operation of autonomous vehicle 100.

Cameras 214 may include RGB cameras, which are configured to capture images based on visible light. Cameras 214 may further include a gated camera, such as gated near infrared (NIR) camera. A gated camera is configured to capture images based on invisible light, such as NIR light. Cameras 214 are configured to capture images of the environment surrounding autonomous vehicle 100 in any aspect or field of view (FOV). The FOV can have any angle or aspect such that images of the areas ahead of, to the side, behind, above, or below autonomous vehicle 100 may be captured. In some embodiments, the FOV may be limited to particular areas around autonomous vehicle 100 (e.g., forward of autonomous vehicle 100, to the sides of autonomous vehicle 100, etc.) or may surround 360 degrees of autonomous vehicle 100. In some embodiments, autonomous vehicle 100 includes multiple cameras 214, and the images from each of the multiple cameras 214 may be stitched or combined to generate a visual representation of the multiple cameras' FOVs, which may be used to, for example, generate a bird's eye view of the environment surrounding autonomous vehicle 100. In some embodiments, the image data generated by cameras 214 may be sent to autonomy computing system 200 or other aspects of autonomous vehicle 100, and this image data may include autonomous vehicle 100 or a generated representation of autonomous vehicle 100. In some embodiments, one or more systems or components of autonomy computing system 200 may overlay labels to the features depicted in the image data, such as on a raster layer or other semantic layer of a high-definition (HD) map.

LiDAR sensors 212 generally include a laser generator and a detector that send and receive a LiDAR signal such that LiDAR point clouds (or “LiDAR images”) of the areas in front of, to the side of, behind, above, or below autonomous vehicle 100 can be captured and represented in the LiDAR point clouds. Radar sensors 210 may include short-range RADAR (SRR), mid-range RADAR (MRR), long-range RADAR (LRR), or ground-penetrating RADAR (GPR). One or more sensors may emit radio waves, and a processor may process received reflected data (e.g., raw radar sensor data) from the emitted radio waves. In some embodiments, the system inputs from cameras 214, radar sensors 210, or LiDAR sensors 212 may be fused or used in combination to determine conditions (e.g., locations of other objects) around autonomous vehicle 100.

GNSS receiver 222 is positioned on autonomous vehicle 100 and may be configured to determine a location of autonomous vehicle 100, which it may embody as GNSS data, as described herein. GNSS receiver 222 may be configured to receive one or more signals from a global navigation satellite system (e.g., Global Positioning System (GPS) constellation) to localize autonomous vehicle 100 via geolocation. In some embodiments, GNSS receiver 222 may provide an input to or be configured to interact with, update, or otherwise utilize one or more digital maps, such as an HD map (e.g., in a raster layer or other semantic map). In some embodiments, GNSS receiver 222 may provide direct velocity measurement via inspection of the Doppler effect on the signal carrier wave. Multiple GNSS receivers 222 may also provide direct measurements of the orientation of autonomous vehicle 100. For example, with two GNSS receivers 222, two attitude angles (e.g., roll and yaw) may be measured or determined. In some embodiments, autonomous vehicle 100 is configured to receive updates from an external network (e.g., a cellular network). The updates may include one or more of position data (e.g., serving as an alternative or supplement to GNSS data), speed/direction data, orientation or attitude data, traffic data, weather data, or other types of data about autonomous vehicle 100 and its environment.

IMU 224 is a micro-electrical-mechanical (MEMS) device that measures and reports one or more features regarding the motion of autonomous vehicle 100, although other implementations are contemplated, such as mechanical, fiber-optic gyro (FOG), or FOG-on-chip (SiFOG) devices. IMU 224 may measure an acceleration, angular rate, and or an orientation of autonomous vehicle 100 or one or more of its individual components using a combination of accelerometers, gyroscopes, or magnetometers. IMU 224 may detect linear acceleration using one or more accelerometers and rotational rate using one or more gyroscopes and attitude information from one or more magnetometers. In some embodiments, IMU 224 may be communicatively coupled to one or more other systems, for example, GNSS receiver 222 and may provide input to and receive output from GNSS receiver 222 such that autonomy computing system 200 is able to determine the motive characteristics (acceleration, speed/direction, orientation/attitude, etc.) of autonomous vehicle 100.

In the example embodiment, autonomy computing system 200 employs vehicle interface 204 to send commands to the various aspects of autonomous vehicle 100 that control the motion of autonomous vehicle 100 (e.g., engine, throttle, steering wheel, brakes, etc.) and to receive input data from one or more sensors 202 (e.g., internal sensors). External interfaces 206 are configured to enable autonomous vehicle 100 to communicate with an external network via, for example, a wired or wireless connection, such as Wi-Fi 226 or other radios 228. In embodiments including a wireless connection, the connection may be a wireless communication signal (e.g., Wi-Fi, cellular, LTE, 5g, Bluetooth, etc.).

In some embodiments, external interfaces 206 may be configured to communicate with an external network via a wired connection 244, such as, for example, during testing of autonomous vehicle 100 or when downloading mission data after completion of a trip. The connection(s) may be used to download and install various lines of code in the form of digital files (e.g., HD maps), executable programs (e.g., navigation programs), and other computer-readable code that may be used by autonomous vehicle 100 to navigate or otherwise operate, either autonomously or semi-autonomously. The digital files, executable programs, and other computer readable code may be stored locally or remotely and may be routinely updated (e.g., automatically or manually) via external interfaces 206 or updated on demand. In some embodiments, autonomous vehicle 100 may deploy with all of the data it needs to complete a mission (e.g., perception, localization, and mission planning) and may not utilize a wireless connection or other connection while underway.

In the example embodiment, autonomy computing system 200 is implemented by one or more processors and memory devices of autonomous vehicle 100. Autonomy computing system 200 includes modules, which may be hardware components (e.g., processors or other circuits) or software components (e.g., computer applications or processes executable by autonomy computing system 200), configured to generate outputs, such as control signals, based on inputs received from, for example, sensors 202. These modules may include, for example, a calibration module 230, a mapping module 232, a motion estimation module 234, a perception and understanding module 236, a behaviors and planning module 238, a control module or controller 240, and a feature alignment module 242. Feature alignment module 242, for example, may be embodied within another module, such as perception & understanding module 236, or separately. These modules may be implemented in dedicated hardware such as, for example, an application specific integrated circuit (ASIC), field programmable gate array (FPGA), or microprocessor, or implemented as executable software modules, or firmware, written to memory and executed on one or more processors onboard autonomous vehicle 100.

Feature alignment module 242 is configured to align features between different modalities during fusion of the feature maps from the different modalities. Feature alignment module 242 is configured to compute attention during feature alignment. An uncertainty-guided attention is applied to increase efficiency in attention computation and accuracy in feature alignment.

Autonomy computing system 200 of autonomous vehicle 100 may be completely autonomous (fully autonomous) or semi-autonomous. In one example, autonomy computing system 200 can operate under Level 5 autonomy (e.g., full driving automation), Level 4 autonomy (e.g., high driving automation), or Level 3 autonomy (e.g., conditional driving automation). As used herein the term “autonomous” includes both fully autonomous and semi-autonomous.

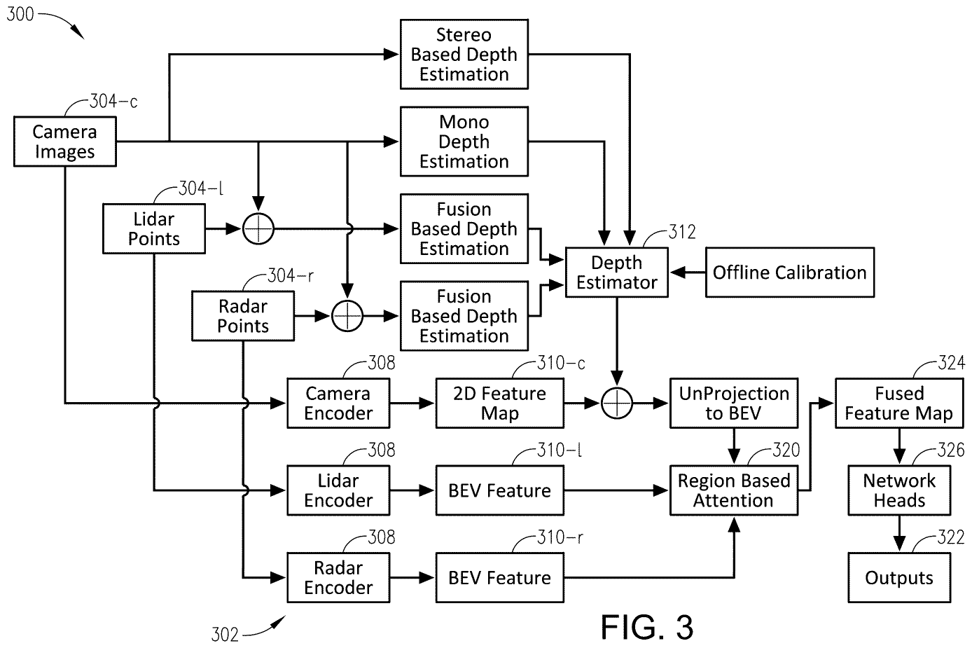

FIG. 3 is a schematic diagram showing architecture 300 of an example neural network model 302 for multimodal fusion. In the example embodiment, neural network model 302 includes feature alignment functionalities. Sensor data 304 are input into neural network model 302. Sensor data 304 are from sensors of a plurality of modalities including a first modality and a second modality. For example, the first modality is camera, which may be stereo cameras, one or more gated cameras, or any combination of both. First sensor data from sensors of the first modality are camera images 304-c. The second modality may be LiDAR, where the second sensor data from sensors of the second modality are LiDAR points 304-1. The second modality may be radar, where the second sensor data are radar points 304-r. In the depicted embodiments, sensor data 304 of sensors from more than two modalities are input into neural network model 302.

In the example embodiment, features of the environment in which autonomous vehicle 100 is operating are extracted. An encoder 308 may be used to extract the features. Encoder 308 is a neural network model configured to extract features from input data. In some embodiments, the features are extracted analytically.

In the example embodiment, sensor data 304 of some modalities inherently include depth information, such as LiDAR data 304-1 and radar data 304-r. Feature maps 310-1, 310-r extracted from LiDAR points 304-1 or radar points 304-r may be directly represented in a bird's eye view (BEV). Senor data 304 of some modalities, such as camera images 304-c, are two dimensional (2D), and the feature map 310-c extracted from camera images 304-c are in 2D. Representing feature map 310-c in the BEV needs depth information.

In the example embodiment, depth information in camera images 304-c is estimated using one or more mechanisms. Depth estimation may be performed online and are of the environment in which autonomous vehicle 100 is operating. As used here, being online refers to that computation and/or determination by autonomy computing system 200 is performed while autonomous vehicle 100 is operating. The depth information may be estimated based on camera images from stereo cameras. The depth information may be estimated using mono-depth estimation. For example, for a gated camera, the depth information is embedded in the sensor data, because in acquiring a picture, a gated camera is gated at a certain point of time or time of flight, and therefore the time of flight is directly related to the depth of the camera image. The depth information may be obtained via a machine learning model trained to determine a depth of an image. The machine learning model may be pretrained. The depth information in camera images may also obtained by fusing camera images with sensor data from another modality, such as LiDAR points or radar points, and determining the depth information based on the fused LiDAR points or the fused radar points. For example, camera images 304-c are fused with LiDAR points 304-1 into fused LiDAR points, and depth information in camera images 304-c is estimated based on the fused LiDAR points. In another example, camera images are fused with radar points into fused radar points, and depth information in camera images is estimated based on the fused radar points. In one more examples, camera images are fused with LiDAR points and radar points, and depth information in camera images is estimated based on the fuse radar and radar points. Depth information estimated based on sensor data using different online mechanisms may be fused in a depth estimator 312 to derive a fused depth information, thereby increasing the accuracy of determined depth information.

In the example embodiments, the depth information in camera images may be estimated from offline calibration. For example, one or more tools, such as a neural network model, are used to calibrate the camera(s). The neural network model is trained to determine the depth in camera images. Testing data including a batch of camera images acquired by cameras and ground truth of depth information are input into the neural network model to calibrate the depth information estimated from camera images. Because the test data may be a large dataset, the calibration is performed offline, where autonomous vehicle 100 is not operating or traveling, thereby improving the accuracy in calibration, without burdening or compromising operation of autonomy computing system 200 and/or autonomous vehicle 100.

In the example embodiment, the depth information estimated with different mechanisms is combined in depth estimator 312 into final depth information for camera images in the downstream processing, such as un-projecting the camera images into the BEV. The final depth information may be any combination of the estimated depth information from different mechanisms.

In the example embodiment, the estimated depth information has uncertainty. In one example, the depth uncertainty is described by a Gaussian distribution. For online depth estimation, the depth uncertainty is determined based on samples or point estimation, due to limited number of samples. The mean and variance of the Gaussian distribution are determined based on the sample data using a specific mechanism. For example, a sample is the estimated depth information using a specific mechanism, and a plurality of samples are from multiple estimates and/or estimates based on sensor data at different time points. The mean and variance associated with that specific mechanism are determined based on samples of depth estimation.

In the example embodiment, the online depth uncertainty N(dₒ,Σ₀) is estimated based on samples of online depth estimation as below:

$${d}_{0} = {\sum }_{i = 1}^{n} {d}_{i} ,$$

$${\sum }_{0} = \frac{1}{n - 1} {\sum }_{i = 1}^{n} {( {d}_{i} - {d}_{0} )}^{2} ,$$

where dᵢ is the i-th sample of estimated depth, n is the total number of samples, dₒ is the mean of the n samples, and Σ₀ is the variance of the n samples.

In the example embodiment, for offline depth calibration, the depth uncertainty is described by a probability distribution, because a relatively large amount of data are available and used, compared to online estimation.

In the example embodiment, the depth uncertainty may be a weighted sum of the depth uncertainty from the online estimation and the depth uncertainty from offline calibration. For example, the depth uncertainty is described as a Gaussian mixture of the depth uncertainty from the online estimation and the depth uncertainty from offline calibration as: αN(d₀,Σ₀)+(1−α)N(d_{f},Σ_{f}), where N(d_{f},Σ_{f}) is a Gaussian distribution having an expectation of d_{f} and standard deviation of Σ_{f} for describing depth uncertainty associated with offline calibration. The weight a may be adjusted and/or predetermined. A combined depth uncertainty of online estimation and offline calibration is advantageous in increasing the accuracy of estimating depth uncertainty, because the combined depth uncertainty reflects uncertainty in detecting the environment in which autonomous vehicle 100 is operating and in the meantime, has increased accuracy from offline calibration due to a relatively large dataset.

In the example embodiment, the features maps are represented in the BEV before fusing the features maps into a fused feature map 324. Feature map 310-1 from LiDAR data 304-1 and feature map 310-r from radar data 304-r are represented the BEV. Feature map 310-c from camera images 304-c are unprojected to the BEV by converting feature map 310-c to be represented in the BEV using the depth information.

In the example embodiment, the feature maps in BEV are fused into a fused features map based on attention between the feature maps. Attention is used in aligning features from different modalities, where features from one modality are weighted with attention for fusing with features from another modality. In machine learning, attention determines the relative importance of a component in a sequence relative to other components in that sequence. Cross-modal attention may be used, where features from different modalities are weighted through attention. In some embodiments, intra-modal attention, or self attention, is also included, where feature points of a modality are weighted relative to neighbor points of the features points. Attention increases the performance of fusing the features. With increased accuracy in feature alignment, the performance of autonomous vehicle 100 is improved.

In the example embodiment, in computing attention, a first region of feature points in a first modality is associated with a second region of feature points in a second modality. The features in the feature maps may be represented as BEV tensors with shape [batch number, channel number, height, weight] for each modality. For example, for camera modality, the BEV tensors are represented with shape [B, C_{c}, H_{c}, W_{c}], and for LiDAR modality, the BEV tensors are represented with shape [B, Cₗ, Hₗ, Wₗ].

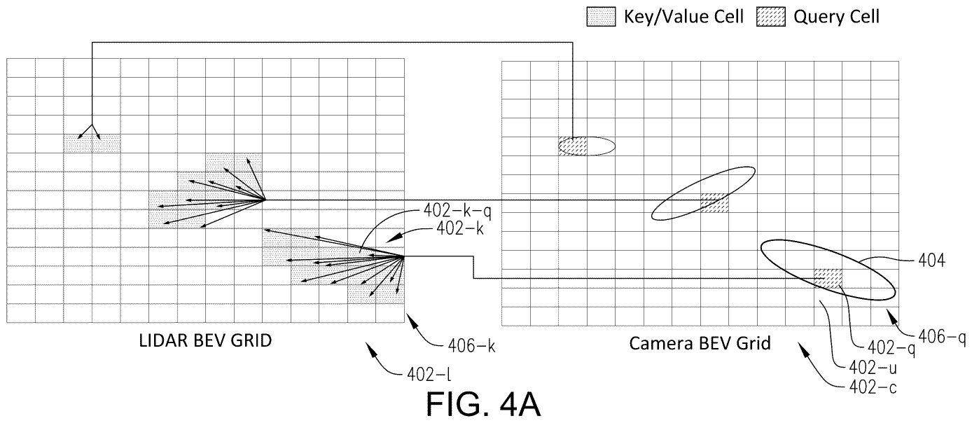

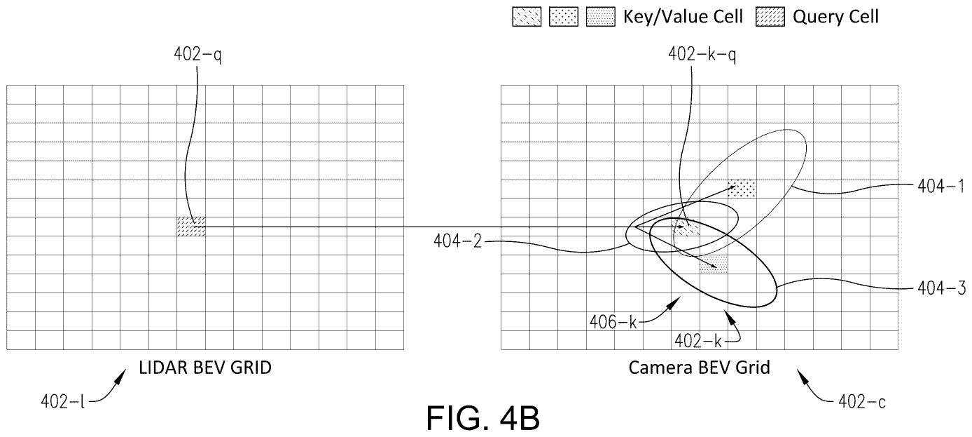

In the example embodiments, queries, keys, and values are generated based on the BEV tensors. In the following example in describing attention O_{i,j} for a cell (i, j), cells in the LiDAR feature map are used as queries and cells in the camera feature are used as keys and values, for illustration purposes only. The BEV tensors from the camera modality may be used as queries and the BEV tensors from the LiDAR modality may be used as keys and values in computing attention between feature maps of the two modalities. A cell 402 (see FIGS. 4A and 4B described later) is a unit in the feature map. A feature map includes feature points at the cells. Cells used as queries may be referred to as query cells. Cells used as keys and values may be referred to as key cells. To obtain enhanced features, all cells in the BEV space is traversed, where each cell x_{i,j} with height index i and width index j in the query BEV tensor is uses as an embedded input for the query. i∈[0, Hₗ−1] and j∈[0, Wₗ−1]. The query of x_{i,j} is computed as:

$${Q}_{i , j} = {W}_{q} \times {x}_{i , j} , \qquad ( 1 )$$

where W_{q} is a linear layer/matrix with an input size of Cₗ and an output size of Cₒ.

Corresponding keys and values may be obtained as:

$${K}_{{i}^{′} , {j}^{′}} = {W}_{k} \times {y}_{{i}^{′} , {j}^{′}} , \qquad ( 2 )$$

$$and$$

$${V}_{{i}^{′} , {j}^{′}} = {W}_{v} \times {cy}_{{i}^{′} , {j}^{′}} , \qquad ( 3 )$$

where y_{i′,j},∈N_{i,j}(i′, j′) is the index of the corresponding camera BEV tensors, and Wₖ and Wᵥ are linear layers/matrices with an input size of C_{c} and output size of Cₒ. N_{i,j} is used to denote the region of cells in the camera BEV space corresponding to the LiDAR cell at (i, j).

Given a query Q_{i,j} of size 1×Cₒ, keys and values of K_{i′,j′} and V_{i′,j′} of a size of n×Cₒ (n is the number of cells or tokens in N_{i,j}), attention O_{i,j} is computed as:

$${O}_{i , j} = softmax ( \frac{Q \times {K}^{T}}{\sqrt{d}} ) \times V , \qquad ( 4 )$$

where d is a scalar value. d may be set the same as Cₒ. Attention O_{i,j} may also be referred to as context tensor O_{i,j}, and is the output corresponding to query Q_{i,j}. Context tensor O_{i,j} is an element of the context feature map at cell (i, j). The output size of the context feature map is [B, Cₒ, Hₗ, Wₗ] because the size of the context tensor is Cₒ and Hₗ×Wₗ queries are used.

When computing attention between features of first and second modalities, queries may be based on feature points of the first modality and keys and values may be based on feature points of the second modality, or vice versa. In some embodiments, both attention is computed, where attention with queries based on feature points of the first modality and keys and values based on feature points of the second modality is computed, as well as attention with queries based on feature points of the second modality and keys and values based on feature points of the first modality. The computed attention is referred to as context feature map Fₐ, where a cell (i, j) may be represented by O_{i,j} as Eqn. (4). The feature map for the modality used as queries may be denoted as F_{q}. The context feature map Fₐ represents features in the modality as keys and values associated with features in the modality as queries, and may be used to enrich the feature map F_{q} of the modality as queries by concatenating the context feature map Fₐ with the query feature map F_{q} into a fused feature map Fₒ for the modality used as queries, as below:

$${F}_{o} = C o n v ( Concat ( {F}_{q} , {F}_{a} ) ) .$$

Output from region-based attention 320 may be in any combination of query feature maps F_{q}, context feature maps Fₐ, and fused feature maps Fₒ. One or more fused feature maps may be output 322 from region-based attention 320. For example, outputs for a first modality may include the context feature map F_{a_1} with attention using queries based on feature points in the feature map of the first modality and keys and values based on feature points in the feature map of another modality, and the fused feature map F_{o_1} that is a fused feature map of the context feature map F_{a_1} with the feature map of the first modality F_{q_1}. Outputs for the first modality may include the feature map of the first modality F_{q_1} if attention is not computed for the first modality. One or more context feature maps for the first modality may be computed, where for each context feature map, keys and values are based on feature points of a different modality. For example, the first modality is camera, the second modality is LiDAR, and the third modality is radar. The context feature map of the camera modality may be a context feature map F_{a_cl} where attention is computed using queries based on feature points from camera images and keys and values based on feature points from LiDAR points, a context feature map F_{a_cr}, where attention is computed using queries based on feature points from camera images and keys and values based on feature points from radar points, or a combination of context feature maps F_{a_cl} and F_{a_cr}. The fused feature map F_{o_c} for the camera modality may be one of the context feature maps, any combination of the context feature maps via concatenation, or the feature map of the camera modality concatenated with any combination of the context feature maps.

In the example embodiments, the fused feature map 324 is input into network heads 326 for further processing, and outputs 322 of neural network model 302 are provided by network heads 326. The outputs may be object present in the environment, such as object class, size, or locations. The outputs may be lanes and properties of the lanes such as locations. Autonomy computing system 200 controls operation of autonomous vehicle 100 based on the outputs. For example, the traveling trajectory of autonomous vehicle 100 may be adjusted in light of objects predicted based on the fused feature map, to avoid collision with the objects. The predicted objects may be included in decision making in operation of autonomous vehicle 100. For example, autonomy computing system 200 may determine to merge or not to merge based on the predicted objects. In another example, autonomy computing system 200 is configured to plan the trajectory of autonomous vehicle 100 based on the detected lane lines.

In the example embodiments, one or more machine learning models may be used in feature alignment. The machine learning model may be a neural network model. Neural network model 302 may be implemented as an overarching machine learning model, which may include one or more sub machine learning models for at least one or more processes in feature alignment.

FIGS. 4A and 4B are schematic diagrams showing example processes of associating cells between different modalities based on uncertainty for attention computation. FIG. 4A shows query cells 402-c are from a camera BEV grid and key/value cells 402-1 are in a LiDAR BEV grid. FIG. 4B shows query cells 402-1 are from a LiDAR BEV grid and key/value cells 402-c are in a camera BEV grid.

In the example embodiment, the sizes of the associated regions between first and second modalities are determined based on uncertainty at specific feature points of the first and second modalities. Uncertainty in a feature map is determined based on depth uncertainty. For example, the depth uncertainty of camera features is used to determine uncertainty in the camera feature map in the BEV. For convenience, the transformation from the camera coordinate system to the BEV coordinate system is denoted as ƒ for [symbol] . The input of the transformation is three dimensional with indexes of x, y, and Z, where x and y are coordinate values of pixels in the pixel coordinate system of camera, and Z is the depth in the camera coordinate system. The output of the transformation is two dimension, BEVₓ and BEV_{y}, which are coordinate values in the BEV coordinate system. The transformation function ƒ may be nonlinear.

In some embodiments, with the uncertainty in the depth value Z and deterministic values of x and y, due to the potentially-nonlinear transformation function ƒ, BEVₓ and BEV_{y} may be in a non-Gaussian distribution if the depth uncertainty is in a Gaussian distribution. An unscented transformation is used to project the depth uncertainty to the BEV space, to provide an approximated Gaussian distribution N(x_{b}, y_{b}) for describing an uncertainty ellipse in the BEV space at x_{b}, y_{b}, where b denotes the BEV space. An unscented transformation is a mathematical function used to estimate results of applying a nonlinear transformation to a probability distribution. As used herein, an ellipse is used to indicate uncertainty, and does not connote the graphical shape of uncertainty. Uncertainty may be distributed in a feature map in any shapes, such as elliptical, circular, linear, irregular, or any combination thereof.

In the example embodiments, in computing attention between two modalities, queries may come from either modality. FIG. 4A shows that camera cells are used as queries. For a given camera cell cᵢⱼ, ith row and jth column in the BEV grid, having a corresponding uncertainty [symbol] (μᵢⱼ,Σᵢⱼ), the association between camera cells cᵢⱼ and LiDAR cells l_{i′j′} is built. Σᵢⱼ is the standard deviation of the distribution of the uncertainty in the BEV feature map of the camera images at camera cell cᵢⱼ. In one example, an ellipse 404 having a size of 3Σᵢⱼ, three times of the standard deviation, is used in association of cells. Using cell 402-q as an example, cell 402-q has an uncertainty ellipse 404. Cell 402-q is used as a query cell. Key cells associated with query cell 402-q include cell 402-k-q corresponding to query cell 402-q itself and cells 402-k corresponding to neighboring cells of query cells 402-q in a region 406-q determined based on uncertainty of the camera feature map. The region 406-q includes the region enclosed by ellipse 404. For a neighboring cell of a cell, if the overlap between the neighboring cell and ellipse 404 of the cell is greater than a threshold, the neighboring cell is included in the region of the cell. The threshold may be predefined or adjustable. For example, if the threshold is 50%, a neighboring cell 402-u of cell 402-q is not included in the association determination because the overlap between cell 402-u and ellipse 404 is less than 50%.

In the example embodiments, the LiDAR cells associated with a camera cell cᵢⱼ are LiDAR cells 402 in a region in the LiDAR BEV grid mapped from uncertainty in the camera feature map. Continuing with the example of cell 402-q, LiDAR cells 402-k associated with cell 402-q are LiDAR cells 402 in region 406-k, as marked in FIG. 4A.

In the example embodiments, referring back to Eqns. (1)-(4), when computing attention for cell cᵢⱼ in a camera feature map, LiDAR cells y_{i′,j′} associated with cᵢⱼ are included in the computation. Continuing with the example for camera cell 402-q, in computing attention for cell 402-q, associated LiDAR cells 402-k determined as above are included in the computation, where region N_{i,j} is shown as region 406-k in FIG. 4A.

In the example embodiments, FIG. 4B shows the association process when LiDAR cells are used as query. In one example, ellipse 404 has a size of 3Σᵢⱼ, three times the standard deviation of the uncertainty at cell (i, j) in the camera feature map. The uncertainty of LiDAR features is relatively low. For simplicity, the uncertainty of LiDAR features is set as zero. A camera cell 402 corresponding to a LiDAR cell 402 may be covered by multiple ellipses 404. For example, for LiDAR cell 402-q, the corresponding camera cell 402-k-q is covered by ellipses 404-1, 404-2, 404-3. Camera cells 402 enclosed by ellipses 404-1, 404-2, 404-3 are determined to be associated with LiDAR cell 402-q in computing attention for LiDAR cell 402-q. Camera cells intersecting ellipse 404 may be determined to be included as associated camera cells for LiDAR cell 402-q based on a threshold, similar to the mechanism described above. Different thresholds may be used in association for a different modality. For example, for association of camera cells, where camera cells are used as queries, the threshold is different from that for association of LiDAR cells, where LiDAR cells are used as queries. Referring back to Eqns. (1)-(4), when computing attention for cell cᵢⱼ in a LiDAR feature map, camera cells y_{i′,j′} associated with cᵢⱼ are included in the computation. For example, for LiDAR cell 402-q, in computing attention for LiDAR cell 402-q, associated camera cells 402-k determined as above are included in the computation, where region N_{i,j} is shown as region 406-k in FIG. 4B.

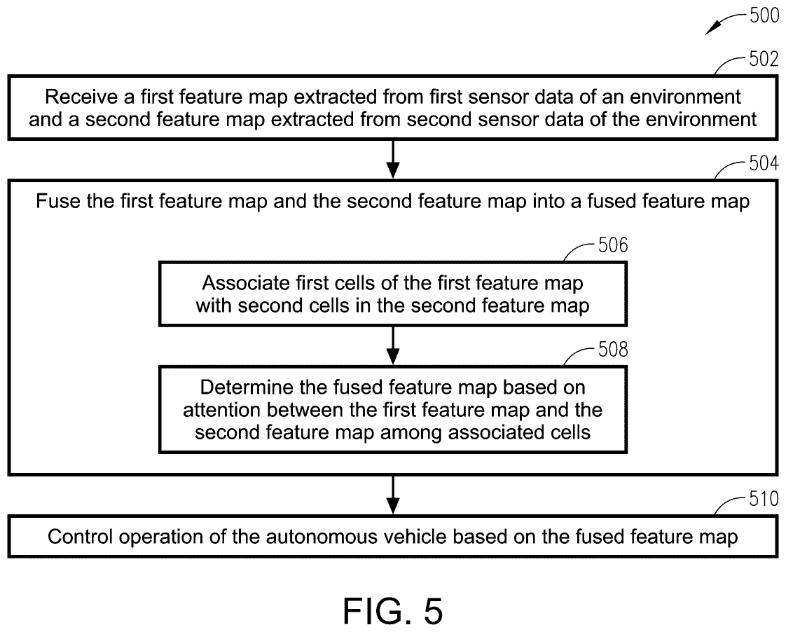

FIG. 5 is a flow chart of an example method 500 for feature alignment. In the example embodiment, method 500 includes receiving 502 a first feature map extracted from first sensor data of an environment and a second feature map extracted from second sensor data of the environment. Autonomous vehicle 100 travels in the environment. The first sensor data are acquired by one or more sensors of a first modality. The second sensor data are acquired by one or more sensors of a second modality. The sensors are installed on the autonomous vehicle. Method 500 further includes fusing 504 the first feature map and the second feature map into a fused feature map. Fusing 504 includes associating 506 first cells of the first feature map with second cells in the second feature map based on at least one of uncertainty in the first feature map or uncertainty in the second feature map. Fusing 504 also includes determining 508 the fused feature map based on attention between the first feature map and the second feature map among associated cells. Method 500 further includes controlling 510 operation of the autonomous vehicle based on the fused feature map.

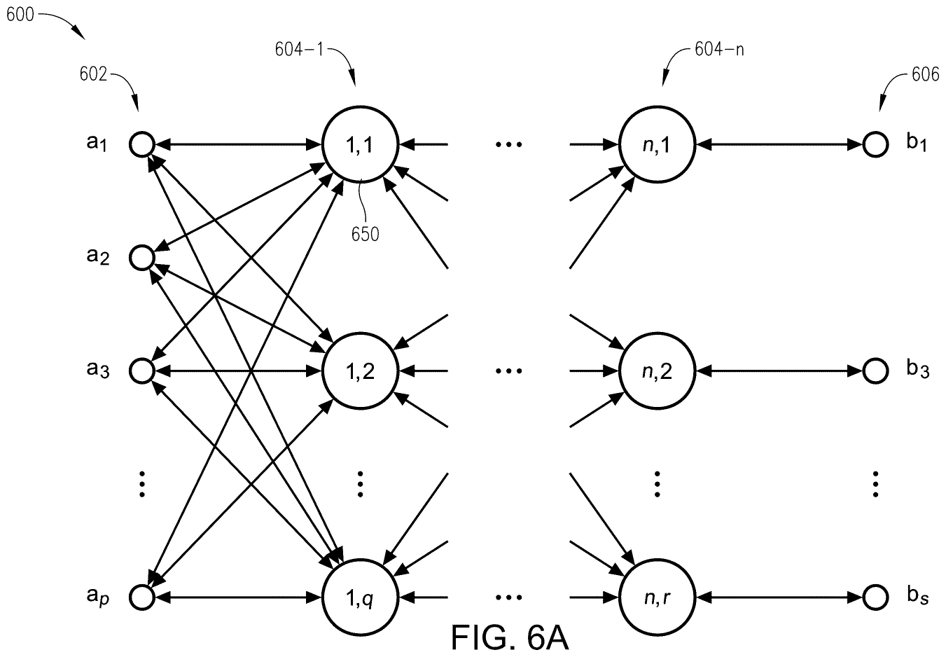

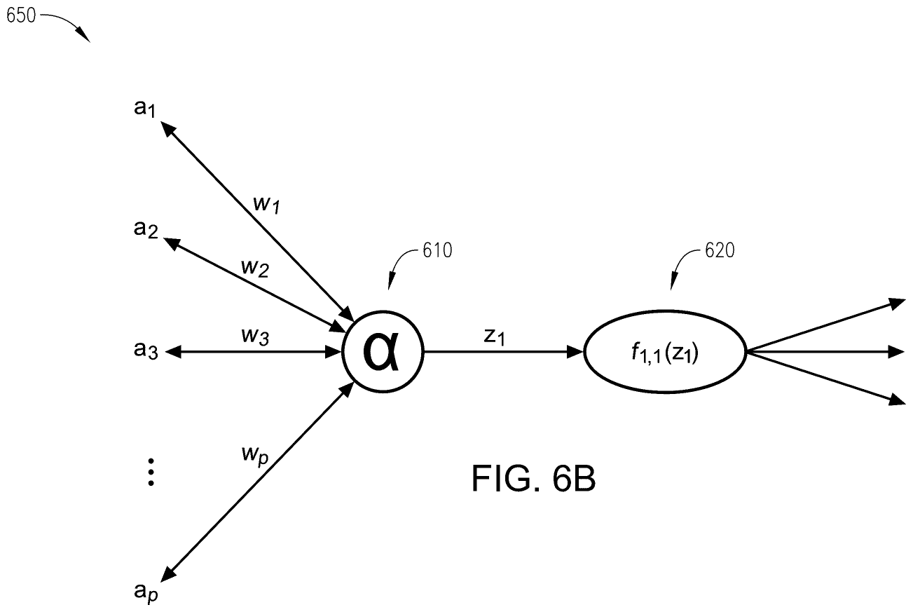

FIG. 6A depicts an example artificial neural network model 600. Method 500 may be implemented with one or more neural network model 600. Architecture 300 and neural network model 302 depicted in FIG. 3 may include one or more neural network models 600. The example neural network model 600 includes layers of neurons 650, 604-1 to 604-n, and 606, including an input layer 602, one or more hidden layers 604-1 through 604-n, and an output layer 606. Each layer may include any number of neurons, i.e., q, r, and n in FIG. 6A may be any positive integer. It should be understood that neural networks of a different structure and configuration from that depicted in FIG. 6A may be used to achieve the methods and systems described herein.

In the example embodiment, the input layer 602 may receive different input data. For example, the input layer 602 includes a first input a₁ representing training images, a second input a₂ representing patterns identified in the training images, a third input a₃ representing edges of the training images, and so on. The input layer 602 may include thousands or more inputs. In some embodiments, the number of elements used by the neural network model 600 changes during the training process, and some neurons are bypassed or ignored if, for example, during execution of the neural network, they are determined to be of less relevance.

In the example embodiment, each neuron in hidden layer(s) 604-1 through 604-n processes one or more inputs from the input layer 602, and/or one or more outputs from neurons in one of the previous hidden layers, to generate a decision or output. The output layer 606 includes one or more outputs each indicating a label, confidence factor, weight describing the inputs, and/or an output image. In some embodiments, however, outputs of the neural network model 600 are obtained from a hidden layer 604-1 through 604-n in addition to, or in place of, output(s) from the output layer(s) 606.

In some embodiments, each layer has a discrete, recognizable function with respect to input data. For example, if n is equal to 3, a first layer analyzes the first dimension of the inputs, a second layer the second dimension, and the final layer the third dimension of the inputs. Dimensions may correspond to aspects considered strongly determinative, then those considered of intermediate importance, and finally those of less relevance.

In other embodiments, the layers are not clearly delineated in terms of the functionality they perform. For example, two or more of hidden layers 604-1 through 604-n may share decisions relating to labeling, with no single layer making an independent decision as to labeling.

FIG. 6B depicts an example neuron 650 that corresponds to the neuron labeled as “1,1” in hidden layer 604-1 of FIG. 6A, according to one embodiment. Each of the inputs to the neuron 650 (e.g., the inputs in the input layer 602 in FIG. 6A) is weighted such that input a₁ through ap corresponds to weights w₁ through wₚ as determined during the training process of the neural network model 600.

In some embodiments, some inputs lack an explicit weight, or have a weight below a threshold. The weights are applied to a function α (labeled by a reference numeral 610), which may be a summation and may produce a value z₁ which is input to a function 620, labeled as ƒ_{1,1}(z₁). The function 620 is any suitable linear or non-linear function. As depicted in FIG. 6B, the function 620 produces multiple outputs, which may be provided to neuron(s) of a subsequent layer, or used as an output of the neural network model 600. For example, the outputs may correspond to index values of a list of labels, or may be calculated values used as inputs to subsequent functions.

It should be appreciated that the structure and function of the neural network model 600 and the neuron 650 depicted are for illustration purposes only, and that other suitable configurations exist. For example, the output of any given neuron may depend not only on values determined by past neurons, but also on future neurons.

The neural network model 600 may include a convolutional neural network (CNN), a deep learning neural network, a reinforced or reinforcement learning module or program, or a combined learning module or program that learns in two or more fields or areas of interest. Supervised and unsupervised machine learning techniques may be used. In supervised machine learning, a processing element may be provided with example inputs and their associated outputs, and may seek to discover a general rule that maps inputs to outputs, so that when subsequent novel inputs are provided the processing element may, based upon the discovered rule, accurately predict the correct output. The neural network model 600 may be trained using unsupervised machine learning programs. In unsupervised machine learning, the processing element may be required to find its own structure in unlabeled example inputs. Machine learning may involve identifying and recognizing patterns in existing data in order to facilitate making predictions for subsequent data. Models may be created based upon example inputs in order to make valid and reliable predictions for novel inputs.

Additionally or alternatively, the machine learning programs may be trained by inputting sample data sets or certain data into the programs, such as images, object statistics, and information. The machine learning programs may use deep learning algorithms that may be primarily focused on pattern recognition, and may be trained after processing multiple examples. The machine learning programs may include Bayesian Program Learning (BPL), voice recognition and synthesis, image or object recognition, optical character recognition, and/or natural language processing—either individually or in combination. The machine learning programs may also include natural language processing, semantic analysis, automatic reasoning, and/or machine learning.

Based upon these analyses, the neural network model 600 may learn how to identify characteristics and patterns that may then be applied to analyzing image data, model data, and/or other data. For example, the model 600 may learn to identify features in a series of data points.

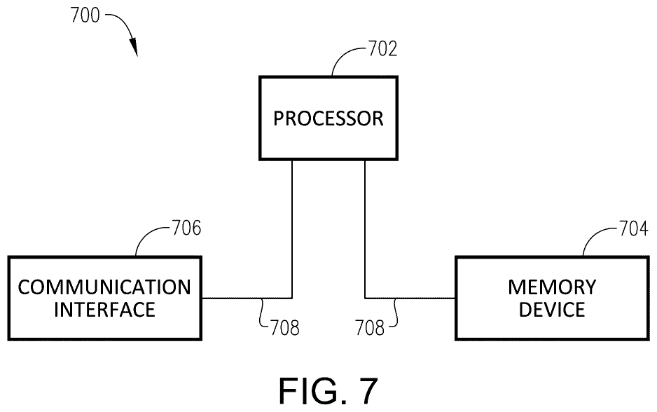

FIG. 7 is a block diagram of an example computing device 700. Autonomy computing system 200 may be implemented with one or more computing devices 700. In the example embodiment, computing device 700 includes a processor 702 and a memory device 704. The processor 702 is coupled to the memory device 704 via a system bus 708. The term “processor” refers generally to any programmable system including systems and microcontrollers, reduced instruction set computers (RISC), complex instruction set computers (CISC), application specific integrated circuits (ASIC), programmable logic circuits (PLC), and any other circuit or processor capable of executing the functions described herein. The above examples are example only, and thus are not intended to limit in any way the definition or meaning of the term “processor.”

In the example embodiment, the memory device 704 includes one or more devices that enable information, such as executable instructions or other data (e.g., sensor data), to be stored and retrieved. Moreover, the memory device 704 includes one or more computer readable media, such as, without limitation, dynamic random access memory (DRAM), static random access memory (SRAM), a solid state disk, or a hard disk. In the example embodiment, the memory device 704 stores, without limitation, application source code, application object code, configuration data, additional input events, application states, assertion statements, validation results, or any other type of data. The computing device 700, in the example embodiment, may also include a communication interface 706 that is coupled to the processor 702 via system bus 708. Moreover, the communication interface 706 is communicatively coupled to data acquisition devices.

In the example embodiment, processor 702 may be programmed by encoding an operation using one or more executable instructions and providing the executable instructions in the memory device 704. In the example embodiment, the processor 702 is programmed to select a plurality of measurements that are received from data acquisition devices.

In operation, a computer executes computer-executable instructions embodied in one or more computer-executable components stored on one or more computer-readable media to implement aspects of the disclosure described or illustrated herein. The order of execution or performance of the operations in embodiments of the disclosure illustrated and described herein is not essential, unless otherwise specified. That is, the operations may be performed in any order, unless otherwise specified, and embodiments of the disclosure may include additional or fewer operations than those disclosed herein. For example, it is contemplated that executing or performing a particular operation before, contemporaneously with, or after another operation is within the scope of aspects of the disclosure.

### Machine Learning & Other Matters

The computer-implemented methods discussed herein may include additional, less, or alternate actions, including those discussed elsewhere herein. The methods may be implemented via one or more local or remote processors, transceivers, and/or sensors (such as processors, transceivers, and/or sensors mounted on mobile devices, or associated with smart infrastructure or remote servers), and/or via computer-executable instructions stored on non-transitory computer-readable media or medium.

Additionally, the computer systems discussed herein may include additional, less, or alternate functionality, including that discussed elsewhere herein. The computer systems discussed herein may include or be implemented via computer-executable instructions stored on non-transitory computer-readable media or medium.

A processor or a processing element may be trained using supervised or unsupervised machine learning, and the machine learning program may employ a neural network, which may be a convolutional neural network, a deep learning neural network, a reinforced or reinforcement learning module or program, or a combined learning module or program that learns in two or more fields or areas of interest. Machine learning may involve identifying and recognizing patterns in existing data in order to facilitate making predictions for subsequent data. Models may be created based upon example inputs in order to make valid and reliable predictions for novel inputs.

Additionally or alternatively, the machine learning programs may be trained by inputting sample (e.g., training) data sets or certain data into the programs, such as conversation data of spoken conversations to be analyzed, mobile device data, and/or additional speech data. The machine learning programs may utilize deep learning algorithms that may be primarily focused on pattern recognition, and may be trained after processing multiple examples. The machine learning programs may include Bayesian program learning (BPL), voice recognition and synthesis, image or object recognition, optical character recognition, and/or natural language processing—either individually or in combination. The machine learning programs may also include natural language processing, semantic analysis, automatic reasoning, and/or other types of machine learning, such as deep learning, reinforced learning, or combined learning.

Supervised and unsupervised machine learning techniques may be used. In supervised machine learning, a processing element may be provided with example inputs and their associated outputs, and may seek to discover a general rule that maps inputs to outputs, so that when subsequent novel inputs are provided the processing element may, based upon the discovered rule, accurately predict the correct output. In unsupervised machine learning, the processing element may be required to find its own structure in unlabeled example inputs. The unsupervised machine learning techniques may include clustering techniques, cluster analysis, anomaly detection techniques, multivariate data analysis, probability techniques, unsupervised quantum learning techniques, associate mining or associate rule mining techniques, and/or the use of neural networks. In some embodiments, semi-supervised learning techniques may be employed. In one embodiment, machine learning techniques may be used to extract data about the conversation, statement, utterance, spoken word, typed word, geolocation data, and/or other data.

An example technical effect of the methods, systems, and apparatus described herein includes at least one of: (a) uncertainty-guided regional attention in feature alignment during multimodal fusion, which increases efficiency in attention computation while increasing the accuracy in feature alignment, (b) uncertainty determined based on the depth uncertainty, or (c) an unscented transformation applied to the depth information, approximating the probability distribution of uncertainty in the BEV space.

Some embodiments involve the use of one or more electronic processing or computing devices. As used herein, the terms “processor” and “computer” and related terms, e.g., “processing device,” and “computing device” are not limited to just those integrated circuits referred to in the art as a computer, but broadly refers to a processor, a processing device or system, a general purpose central processing unit (CPU), a graphics processing unit (GPU), a microcontroller, a microcomputer, a programmable logic controller (PLC), a reduced instruction set computer (RISC) processor, a field programmable gate array (FPGA), a digital signal processor (DSP), an application specific integrated circuit (ASIC), and other programmable circuits or processing devices capable of executing the functions described herein, and these terms are used interchangeably herein. These processing devices are generally “configured” to execute functions by programming or being programmed, or by the provisioning of instructions for execution. The above examples are not intended to limit in any way the definition or meaning of the terms processor, processing device, and related terms.

The various aspects illustrated by logical blocks, modules, circuits, processes, algorithms, and algorithm steps described above may be implemented as electronic hardware, software, or combinations of both. Certain disclosed components, blocks, modules, circuits, and steps are described in terms of their functionality, illustrating the interchangeability of their implementation in electronic hardware or software. The implementation of such functionality varies among different applications given varying system architectures and design constraints. Although such implementations may vary from application to application, they do not constitute a departure from the scope of this disclosure.

Aspects of embodiments implemented in software may be implemented in program code, application software, application programming interfaces (APIs), firmware, middleware, microcode, hardware description languages (HDLs), or any combination thereof. A code segment or machine-executable instruction may represent a procedure, a function, a subprogram, a routine, a subroutine, a module, a software package, a class, or any combination of instructions, data structures, or program statements. A code segment may be coupled to, or integrated with, another code segment or an electronic hardware by passing or receiving information, data, arguments, parameters, memory contents, or memory locations. Information, arguments, parameters, data, etc. may be passed, forwarded, or transmitted via any suitable means including memory sharing, message passing, token passing, network transmission, etc.

The actual software code or specialized control hardware used to implement these systems and methods is not limiting of the claimed features or this disclosure. Thus, the operation and behavior of the systems and methods were described without reference to the specific software code being understood that software and control hardware can be designed to implement the systems and methods based on the description herein.

When implemented in software, the disclosed functions may be embodied, or stored, as one or more instructions or code on or in memory. In the embodiments described herein, memory includes non-transitory computer-readable/machine-readable media, which may include, but is not limited to, media such as flash memory, a random access memory (RAM), read-only memory (ROM), erasable programmable read-only memory (EPROM), electrically erasable programmable read-only memory (EEPROM), and non-volatile RAM (NVRAM). As used herein, the term “non-transitory computer-readable media” is intended to be representative of any tangible, computer-readable media, including, without limitation, non-transitory computer storage devices, including, without limitation, volatile and non-volatile media, and removable and non-removable media such as a firmware, physical and virtual storage, CD-ROM, DVD, and any other digital source such as a network, a server, cloud system, or the Internet, as well as yet to be developed digital means, with the sole exception being a transitory propagating signal. The methods described herein may be embodied as executable instructions, e.g., “software” and “firmware,” in a non-transitory computer-readable medium. As used herein, the terms “software” and “firmware” are interchangeable and include any computer program stored in memory for execution by personal computers, workstations, clients, and servers. Such instructions, when executed by a processor, configure the processor to perform at least a portion of the disclosed methods.

As used herein, an element or step recited in the singular and proceeded with the word “a” or “an” should be understood as not excluding plural elements or steps unless such exclusion is explicitly recited. Furthermore, references to “one embodiment” of the disclosure or an “exemplary” or “example” embodiment are not intended to be interpreted as excluding the existence of additional embodiments that also incorporate the recited features. Likewise, limitations associated with “one embodiment” or “an embodiment” should not be interpreted as limiting to all embodiments unless explicitly recited.

Disjunctive language such as the phrase “at least one of X, Y, or Z,” unless specifically stated otherwise, is generally intended, within the context presented, to disclose that an item, term, etc. may be either X, Y, or Z, or any combination thereof (e.g., X, Y, and/or Z). Likewise, conjunctive language such as the phrase “at least one of X, Y, and Z,” unless specifically stated otherwise, is generally intended, within the context presented, to disclose at least one of X, at least one of Y, and at least one of Z.

The disclosed systems and methods are not limited to the specific embodiments described herein. Rather, components of the systems or steps of the methods may be utilized independently and separately from other described components or steps.

This written description uses examples to disclose various embodiments, which include the best mode, to enable any person skilled in the art to practice those embodiments, including making and using any devices or systems and performing any incorporated methods. The patentable scope is defined by the claims and may include other examples that occur to those skilled in the art. Such other examples are intended to be within the scope of the claims if they have structural elements that do not differ from the literal language of the claims, or if they include equivalent structural elements with insubstantial differences form the literal language of the claims.

What is claimed is:

1. An autonomy computing system of an autonomous vehicle for feature alignment in multimodal fusion, comprising at least one processor in communication with at least one memory device, and the at least one processor programmed to:
receive a first feature map extracted from first sensor data of an environment and a second feature map extracted from second sensor data of the environment, wherein the autonomous vehicle is operating in the environment, the first sensor data being from one or more sensors of a first modality and the second sensor data being from one or more sensors of a second modality, the one or more sensors of the first modality and the one or more sensors of the second modality installed on the autonomous vehicle;
fuse the first feature map and the second feature map into a fused feature map by:
associating first cells in the first feature map with second cells in the second feature map based on at least one of uncertainty in the first feature map or uncertainty in the second feature map; and
determining the fused feature map based on attention between the first feature map and the second feature map among associated cells; and
control operation of the autonomous vehicle based on the fused feature map.

2. The autonomy computing system of claim 1, wherein the at least one processor is further programmed to:
associate the first cells by:
for a query cell among the first cells, associating the query cell with key cells in the second feature map, wherein the key cells correspond to the query cell and neighboring cells of the query cell in one or more regions determined based on at least one of the uncertainty in the first feature map or the uncertainty in the second feature map.

3. The autonomy computing system of claim 1, wherein the at least one processor is further programmed to:
determine the fused feature map by:
computing the attention between the first feature map and the second feature map among the associated cells, wherein queries are based on query cells in one modality and keys and values are based on key cells in the other modality associated with the query cells.

4. The autonomy computing system of claim 1, wherein the first sensor data is two-dimensional (2D), the at least one processor further programmed to:
compute depth information of the first sensor data; and
determine depth uncertainty based on the depth information.

5. The autonomy computing system of claim 4, wherein the at least one processor is further programmed to:
determine the uncertainty in the first feature map based on the depth uncertainty.

6. The autonomy computing system of claim 4, wherein the at least one processor is further programmed to:
determine the uncertainty in the first feature map by applying an unscented transformation to the depth uncertainty.

7. The autonomy computing system of claim 4, wherein the at least one processor is further programmed to:
determine the depth uncertainty as statistics of a probability distribution of the depth uncertainty as a Gaussian distribution.

8. The autonomy computing system of claim 1, wherein the at least one processor is further programmed to:
compute the uncertainty in the first feature map as a weighted sum of uncertainty determined online and uncertainty based on offline calibration.

9. The autonomy computing system of claim 1, wherein the at least one processor is further programmed to:
concatenate a context feature map based on the attention and a query feature map into the fused feature map, the query feature map being at least one of the first feature map or the second feature map used as queries in computing the attention.

10. The autonomy computing system of claim 1, wherein the first sensor data is two-dimensional (2D), the at least one processor further programmed to:
estimate depth information of the first sensor data by:
estimating first depth information using a first mechanism;
estimating second depth information using a second mechanism; and
fusing the first depth information and the second depth information into the depth information of the first sensor data.

11. A method for feature alignment in multimodal fusion of features in an environment of an autonomous vehicle, the method comprising:
receiving a first feature map extracted from first sensor data of the environment and a second feature map extracted from second sensor data of the environment, wherein the autonomous vehicle is operating in the environment, the first sensor data being from one or more sensors of a first modality and the second sensor data being from one or more sensors of a second modality, the one or more sensors of the first modality and the one or more sensors of the second modality installed on the autonomous vehicle;
fusing the first feature map and the second feature map into a fused feature map by:
associating first cells in the first feature map with second cells in the second feature map based on at least one of uncertainty in the first feature map or uncertainty in the second feature map; and
determining the fused feature map based on attention between the first feature map and the second feature map among associated cells; and
controlling operation of the autonomous vehicle based on the fused feature map.

12. The method of claim 11, wherein associating the first cells further comprises:
for a query cell among the first cells, associating the query cell with key cells in the second feature map, wherein the key cells correspond to the query cell and neighboring cells of the query cell in one or more regions determined based on at least one of the uncertainty in the first feature map or the uncertainty in the second feature map.

13. The method of claim 11, wherein determining the fused feature map further comprises:
computing the attention between the first feature map and the second feature map among the associated cells, wherein queries are based on query cells in one modality and keys and values are based on key cells in the other modality associated with the query cells.

14. The method of claim 11, wherein the first sensor data is two-dimensional (2D), associating the first cells further comprising:
computing depth information of the first sensor data; and
determining depth uncertainty based on the depth information.

15. The method of claim 14, wherein associating the first cells further comprises:
determining the uncertainty in the first feature map based on the depth uncertainty.

16. The method of claim 14, wherein associating the first cells further comprises:
determining the uncertainty in the first feature map by applying an unscented transformation to the depth uncertainty.

17. The method of claim 14, wherein associating the first cells further comprises:
determining the depth uncertainty as statistics of a probability distribution of the depth uncertainty as a Gaussian distribution.

18. The method of claim 11, wherein associating the first cells further comprises:
computing the uncertainty in the first feature map as a weighted sum of uncertainty determined online and uncertainty based on offline calibration.

19. The method of claim 11, wherein determining the fused feature map further comprises:
concatenating a context feature map based on the attention and a query feature map into the fused feature map, the query feature map being at least one of the first feature map or the second feature map used as queries in computing the attention.

20. The method of claim 11, wherein the first sensor data is two-dimensional (2D), associating the first cells further comprising:
estimating depth information of the first sensor data by:
estimating first depth information using a first mechanism;
estimating second depth information using a second mechanism; and
fusing the first depth information and the second depth information into the depth information of the first sensor data.
